(19) United States
(12) Patent Application Publication
(10) Pub. No.: US 2022/0360717 A1
(43) Pub. Date: Nov. 10, 2022

(54) IMAGE CAPTURE DEVICE

(71) Applicant: SHARP KABUSHIKI KAISHA, Osaka (JP)

(72) Inventors: DAISHI MIYAZAKI, Osaka (JP); HIDENORI FUJISAWA, Osaka (JP)

(21) Appl. No.: 17/722,149

(22) Filed: Apr. 15, 2022

(30) Foreign Application Priority Data
May 7, 2021 (JP) 2021-079364

(51) Int. Cl. H04N 5/232; H04N 5/225

(52) U.S. Cl. CPC H04N 5/23296; H04N 5/232933; H04N 5/2258

(57) ABSTRACT

A portable terminal, which is an image capture device, includes an ultra wide-angle camera that has a 35 mm equivalent focal length of 20 mm or less, a display unit that displays a captured image, a zoom processor that zooms in/out on the captured image, and an operation unit that receives input of the amount of the zoom process. In default shooting by the camera, the zoom processor performs the zoom process to obtain a focal length of a predetermined value between about 23 mm and about 26 mm in 35 mm equivalent, and the angle of view obtained through the zoom process is used as the default angle of view.

### BACKGROUND

### 1. Field

The present disclosure relates to an image capture device.

### 2. Description of the Related Art

In the related art, image capture devices, such as smartphones and mobile phones, having wide-angle cameras are known (for example, International Publication No. 2018/070114). The 35 mm equivalent focal length corresponding to the angle of view of a wide-angle camera is typically between about 23 mm and about 26 mm.

These days, image capture devices, each of which has, in addition to a wide-angle camera, an ultra wide-angle camera or a telephoto camera, or both of them, are supplied to the market. The 35 mm equivalent focal length of an ultra wide-angle camera is typically about 20 mm or less. The 35 mm equivalent focal length of a telephoto camera is about 50 mm, about 70 mm, or about 120 mm depending on its model, and is typically defined to be about 50 mm or more.

Also in such an image capture device having multiple cameras of different angles of view, the default angle of view for shooting is set to the full angle of view of the wide-angle camera similarly to products, of the related art, which have only wide-angle cameras.

The configuration of having both a wide-angle camera and an ultra wide-angle camera as multiple cameras of different angles of view inevitably leads to high cost because of the two cameras.

It is desirable to provide, at low cost, an image capture device which has high usability and which provides an operational feeling of having both a wide-angle camera and an ultra wide-angle camera.

### SUMMARY

According to an aspect of the disclosure, there is provided an image capture device including an image capture unit, a display unit, a zoom processor, and a reception unit. The image capture unit has a 35 mm equivalent focal length of 20 mm or less. The display unit displays an image captured by the image capture unit. The zoom processor zooms in/out on an image captured by the image capture unit. The reception unit receives input of the amount of a process performed by the zoom processor. In default shooting by the image capture unit, the zoom processor performs a zoom process to obtain a focal length of a predetermined value between 23 mm and 26 mm in 35 mm equivalent, and an angle of view obtained through the zoom process is used as a default angle of view.

### BRIEF DESCRIPTION OF THE DRAWINGS

FIG. 1 is a diagram for describing the appearance of a portable terminal according to the present embodiment;

FIG. 2 is a block diagram illustrating an exemplary schematic functional configuration of the portable terminal illustrated in FIG. 1;

FIG. 3 is a schematic view of an exemplary structure of a camera included in the portable terminal illustrated in FIG. 1;

FIG. 4 is a diagram illustrating the image capture area of the portable terminal illustrated in FIG. 1, and the image capture area of a portable terminal, of the related art, which has three cameras, an ultra wide-angle camera, a wide-angle camera, and a telephoto camera;

FIG. 5 is a diagram illustrating the full angle of view and the default angle of view of the camera in the portable terminal illustrated in FIG. 1;

FIG. 6 is a diagram illustrating a table describing the relationship between internal zoom factor and UI-display zoom factor of the camera in the portable terminal illustrated in FIG. 1; and

FIG. 7 is a diagram for describing the flow of an image capture process of the portable terminal illustrated in FIG. 1.

### DESCRIPTION OF THE EMBODIMENTS

Referring to the drawings, an image capture device according to embodiments of the present disclosure will be described below. In the description below, identical components are designated with an identical reference numeral. Their names and functions are the same. Accordingly, the detailed and repeated description will be avoided.

Examples of an image capture device include a portable terminal such as a smartphone, a tablet computer, and a digital camera. Description will be made below by taking, as an example, a portable terminal having an image capture function.

### The Configuration of a Portable Terminal

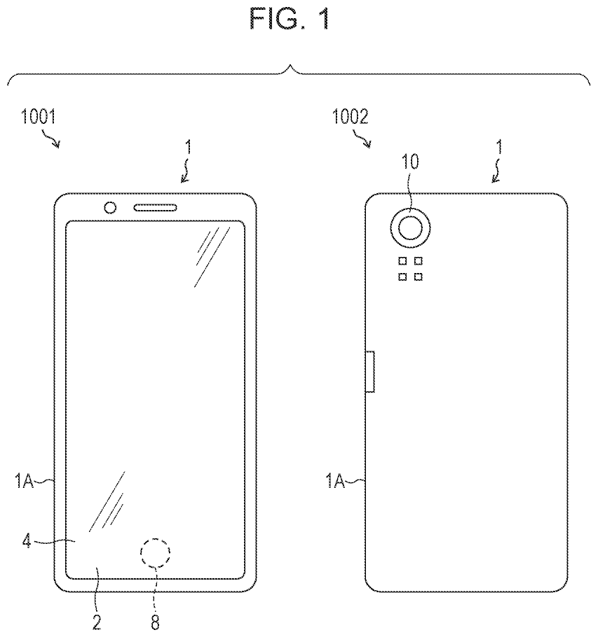

FIG. 1 is a diagram for describing the appearance of a portable terminal 1 according to the present embodiment. A front view 1001 and a back view 1002 of the portable terminal 1 are illustrated.

As illustrated in the front view 1001, the portable terminal 1 includes, for example, a display unit 2 and an operation unit 4 on the front side surface of a case 1A. The display unit 2 has a touch panel function, and includes the operation unit (reception unit) 4. As illustrated in the back view 1002, the portable terminal 1 includes a camera (image capture unit) 10 on the back side surface opposite the front side surface of the case 1A. The camera 10 captures an image of a subject viewed from a user (image capture person).

When a user starts up, by using the portable terminal 1, an application (hereinafter referred to as an “image capture application”) for performing the image capture function, the camera 10 starts capturing an image, and the display unit 2 displays the image, which is captured by the camera 10, and an image capture switch 8. Hereinafter, starting up an application for performing the image capture function is referred to as starting the camera 10. Terminating the application is referred to as stopping the camera 10.

When a user touches the image capture switch 8, the portable terminal 1 captures the image, which is being displayed on the display unit 2, as a photograph. In the case of a movie, the portable terminal 1 starts capturing a movie. When a user touches the display unit 2 to perform a zoom-in operation for magnifying, for display, the touched part of the image, the display unit 2 displays the magnified image. When the user touches the display unit 2 to perform a zoom-out operation for demagnifying, for display, the touched part of the image, the display unit 2 displays the demagnified image.

The scaling factor of a magnified image is determined depending on the amount of a zoom-in operation. Similarly, the scaling factor of a demagnified image is determined depending on the amount of a zoom-out operation. Limit factors are set for the magnification factor and the demagnification factor, respectively. Magnification and demagnification are performed up to the respective limit factors.

### The Functional Blocks of the Portable Terminal

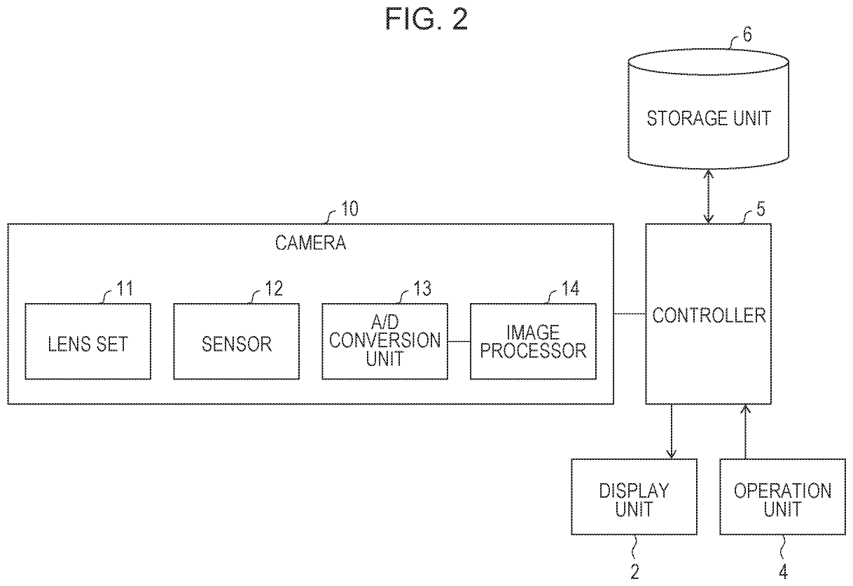

FIG. 2 is a block diagram illustrating an exemplary schematic functional configuration of the portable terminal 1. The portable terminal 1 includes a controller 5 and a storage unit 6 in addition to the camera 10, the display unit 2, and the operation unit 4 which are described above.

The controller 5 controls the camera 10 and the display unit 2 through execution of control programs. The controller 5 reads, for execution, the control programs, which are stored in the storage unit 6, to a temporary storage unit (not illustrated), which is formed, for example, of a random access memory (RAM), to perform various processes. The controller 5 has functions of a zoom processor which zooms in/out on an image captured by the camera 10.

The operation unit 4 receives input of various operation commands which are submitted from a user and which include operation commands to the camera 10. The operation unit 4 also serves as a reception unit which receives input of the amount of a process performed by an image processor (zoom processor) 14 described below. In the present embodiment, for example, the operation unit 4 is used as the touch panel function of the display unit 2. Alternatively, the touch panel function may be implemented, for example, by using an operation button and its interface.

The display unit 2 displays various images including an image captured by the camera 10. The display unit 2 is, for example, a liquid-crystal display or a self-luminous display, such as an organic light-emitting diode (OLED).

The storage unit 6 stores the following programs and data: (1) control programs for the units, (2) operating system (OS) programs, and (3) various application programs including the image capture application, which are executed by the controller 5; (4) various types of data which are read in execution of these programs.

The camera 10 includes a lens set 11, a sensor 12, an analog/digital (A/D) conversion unit 13, and the image processor 14. The camera 10 captures an image through the sensor 12 receiving light for image capture. A photocurrent generated by the sensor 12 receiving light for image capture is transmitted to the A/D conversion unit 13. The A/D conversion unit 13 converts an analog signal, which is output from the sensor 12, to a digital signal.

The image processor 14 performs image processing on an image (image data) from the A/D conversion unit 13. The image processing includes a pixel interpolation process and a color conversion process which are predetermined. The image processor 14 receives, through the controller 5, operation commands to the camera 10, which are input from a user to the operation unit 4, and performs various processes. An image generated by the image processor 14 is transmitted to the controller 5, and is displayed on the display unit 2 through the controller 5. An image displayed on the display unit 2 may be stored in the storage unit 6.

### The Configuration of the Camera 10

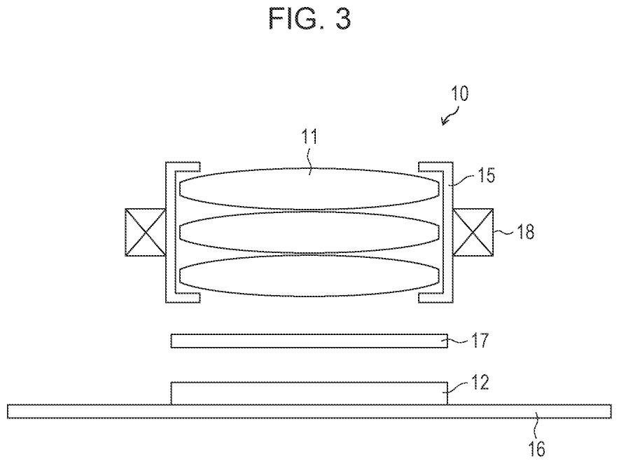

FIG. 3 is a schematic view of an exemplary structure of the camera 10 included in the portable terminal 1. As illustrated in FIG. 3, the camera 10 includes the lens set 11, the sensor 12, an actuator 18, and lid glass 17.

The lens set 11 includes multiple lenses stacked on top of one another. The lenses are assembled in a lens barrel 15 as a single unit. The sensor 12 is, for example, a color image sensor or a monochrome image sensor, which is formed, for example, of a complementary metal oxide semiconductor (CMOS) or a charge-coupled device (CCD). The sensor 12, which is mounted on a substrate 16, converts an optical signal, which is received as light through the lens set 11, to an electric signal.

The actuator 18 is formed, for example, of a voice coil motor (VCM). The actuator 18 controls the lens set 11 driven in the optical axis direction, and performs the autofocus (AF) function. The lid glass 17, which has transmission characteristics, passes light of a predetermined wavelength, and blocks light of the other wavelengths.

The camera 10, which has the configuration described above, is a so-called ultra wide-angle camera having a 35 mm equivalent focal length of about 20 mm or less. In the default shooting by the camera 10, the portable terminal 1 performs a zoom process to obtain a focal length of a predetermined value between about 23 mm and about 26 mm in 35 mm equivalent. The angle of view obtained through zooming is set to the default angle of view. That is, in the default shooting by the camera 10, the portable terminal 1 does not display, on the display unit 2, an image having the full angle of view of the camera 10 which is an ultra wide-angle camera. Instead, the portable terminal 1 displays, on the display unit 2, an image which is obtained through zooming (magnification) and which has a focal length of the predetermined value between about 23 mm and about 26 mm in 35 mm equivalent. The portable terminal 1 operates the magnified image as an image having a zoom factor of one.

### The Default of the Camera 10 in the Portable Terminal 1

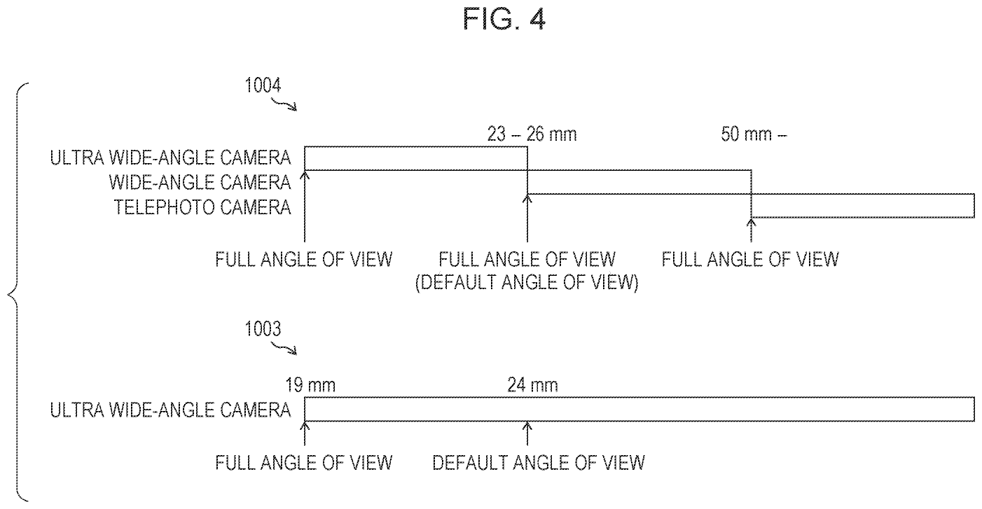

FIG. 4 is a diagram illustrating the image capture area of the portable terminal 1 and the image capture area of a portable terminal, of the related art, which has three cameras, an ultra wide-angle camera, a wide-angle camera, and a telephoto camera. An image capture area 1003 of the portable terminal 1, and an image capture area 1004 of the portable terminal of the related art are illustrated.

As illustrated by using the image capture area 1004, the portable terminal, which has three cameras, of the related art has a default angle of view which is the full angle of view of the wide-angle camera. Typically, the full angle of view of a wide-angle camera corresponds to a 35 mm equivalent focal length between about 23 mm and about 26 mm, depending on its model. In FIG. 4, the left ends of the ranges of the ultra wide-angle camera, the wide-angle camera, and the telephoto camera indicate their respective full angles of view. The ranges to the right of the full angles of view indicate the respective angles of view (zoom-processed angles of view), which are obtained through zooming.

As illustrated by using the image capture area 1003, the portable terminal 1 according to the present embodiment has a default angle of view corresponding to a focal length of about 24 mm in 35 mm equivalent. The focal length of about 24 mm is obtained by performing a zoom process on an image captured with a focal length of about 19 mm in 35 mm equivalent. The focal length of about 19 mm is compatible with an ultra wide-angle camera whose focal length is about 20 mm or less in 35 mm equivalent.

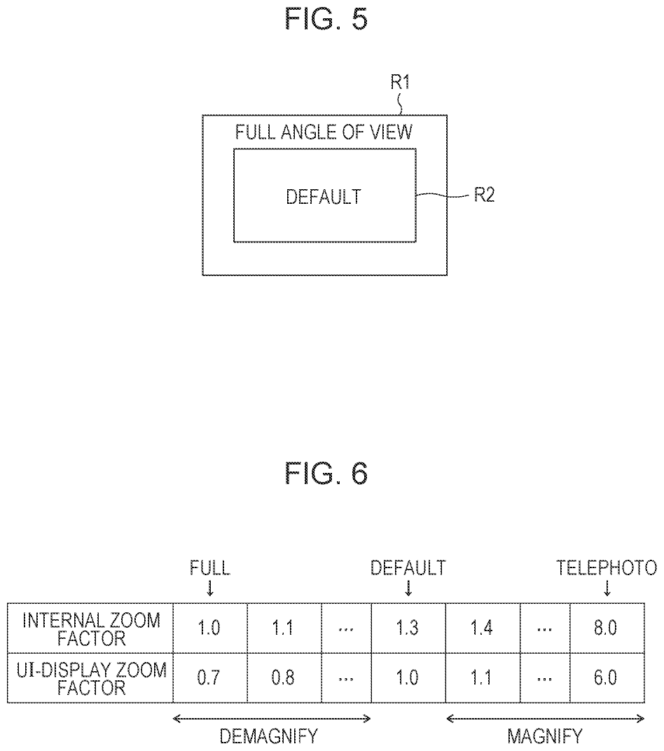

FIG. 5 is a diagram illustrating the full angle of view and the default angle of view of the camera 10 in the portable terminal 1. As illustrated in FIG. 5, the default angle-of-view R2 of the camera 10 is smaller than the full angle-of-view R1 of the camera 10. The portable terminal 1 displays an image (image data), having the default angle-of-view R2, on the display unit 2 through zooming. The operation unit 4 receives zoom-in operations and zoom-out operations by using, as a reference, the image having the default angle-of-view R2. That is, the state, in which an image magnified from the angle-of-view R2 is displayed on the display unit 2, indicates a scaling factor of “1.0” on the user interface (UI).

In the present embodiment, the 35 mm equivalent focal length corresponding to the full angle-of-view R1 of the camera 10 is, for example, about 19 mm (an angle of view of about 98°). In the present embodiment, the 35 mm equivalent focal length corresponding to the default angle-of-view R2 is set, for example, to about 24 mm (an angle of view of about 82°).

That is, in the present embodiment, a scaling factor of “about 1.3 (24 mm/19 mm)” of the image processor 14 of the camera 10 is set to a scaling factor of “1.0”, on the UI, which is used as a reference for user operation. Hereinafter, a scaling factor of the image processor 14 is also referred to as an internal zoom factor; a scaling factor on the UI is also referred to as a UI-display zoom factor.

FIG. 6 is a diagram illustrating a table T describing the relationship between the internal zoom factor and the UI-display zoom factor of the camera 10 in the portable terminal 1. The table T is stored, for example, in the storage unit 6, and is read by the controller 5 of the portable terminal 1. When the camera 10 is started, the controller 5 reads the table T, and displays, on the display unit 2, an image having been magnified with the internal zoom factor of “1.3” which corresponds to a UI-display zoom factor of “1.0”. When a user performs a zoom-in operation to specify, for example, a UI-display zoom factor of “1.1”, the controller 5 displays, on the display unit 2, an image which has been magnified with the internal zoom factor of “1.4” and which is magnified from the default (the internal zoom factor of “1.3”). When a user performs a zoom-out operation to specify, for example, a UI-display zoom factor of “0.7”, the controller 5 displays, on the display unit 2, an image which has been demagnified with an internal zoom factor of “1.0” and which is demagnified from the default (the internal zoom factor of “1.3”). An image demagnified from the default is a wider angle image including a wider area than that of the default.

The internal zoom factors, which are actual zoom factors, are associated with the UI-display zoom factors, which are zoom factors viewed from users, as described above. Thus, by using the default angle of view as a zoom factor of one, the operation unit 4 receives input of the amount of a process to be performed. Accordingly, even when the default angle of view is an angle of view obtained through zooming, a user may capture an image by using the camera 10 just like a product of the related art without feeling uncomfortable.

In the present embodiment, as described above, the controller 5 of the portable terminal 1, which has functions of a zoom processor, magnifies an image (image data) captured by the camera 10. Therefore, in the default shooting, the controller 5 displays, on the display unit 2, an image obtained by magnifying, with the internal zoom factor of “1.3”, an image which has the full angle of view and which is transmitted from the camera 10. When a zoom-in or zoom-out operation is performed to transmit an instruction to make a change from the UI-display zoom factor of “1.0”, the controller 5 magnifies or demagnifies the image in accordance with the amount, which is specified in the instruction, by using, as a reference, the image magnified with the internal zoom factor of “1.3”, and displays the magnified or demagnified image on the display unit 2.

The image processor 14 of the camera 10 may zoom in/out on an image captured by the camera 10. In this case, the image processor 14 of the camera 10 may include the table T. Alternatively, the controller 5 may transmit, to the image processor 14 of the camera 10, the table T read from the storage unit 6. In the configuration in which the image processor 14 of the camera 10 performs a zoom process, the image processor 14 transmits, to the controller 5, an image magnified with the internal zoom factor corresponding to a UI-display zoom factor.

### An Image Capture Operation in the Portable Terminal 1

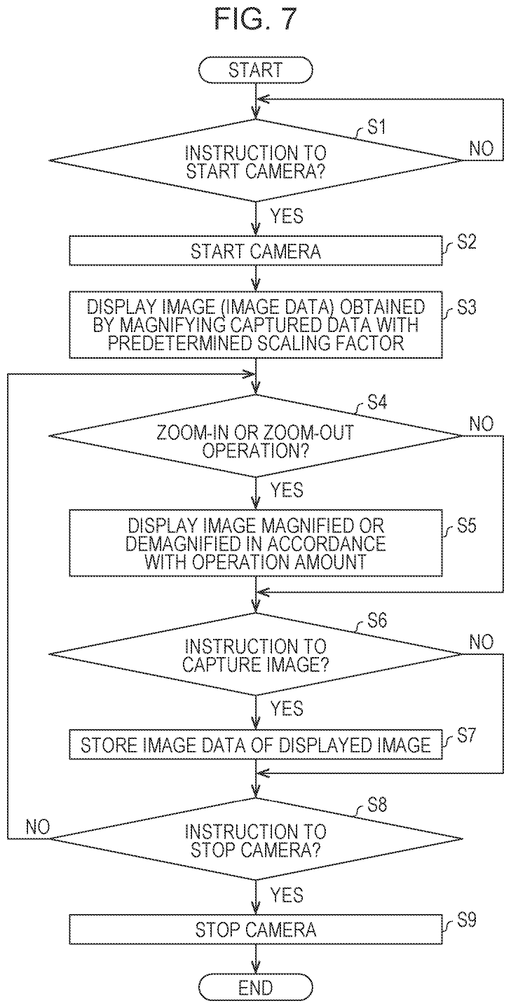

FIG. 7 is a diagram for describing the flow of an image capture process performed by the portable terminal 1. The controller 5 repeatedly determines whether an instruction to start the camera 10 has been transmitted (S1). For example, when a user operates an icon or the like of the image capture application, which is displayed on the display unit 2, the controller 5 determines that an instruction to start the camera 10 has been transmitted. If the controller 5 determines that an instruction to start the camera 10 has been transmitted (YES in S1), the controller 5 starts the camera 10 (S2). The camera 10, which has been started, starts capturing an image.

The controller 5 displays, on the display unit 2, an image which serves as a default image and which is obtained by magnifying an image (image data), which is captured by the camera 10, with a predetermined scaling factor, in this example, a scaling factor of 1.3. Even when the orientation of the portable terminal 1 is changed and subjects captured by the camera 10 are changed, as long as a zoom-in (magnification) operation or a zoom-out (demagnification) operation is not performed, the image obtained by magnifying the captured image with the scaling factor of 1.3 is displayed on the display unit 2.

After the camera 10 starts, the controller 5 repeatedly determines whether a zoom-in operation or a zoom-out operation has been performed (S4). If the controller 5 determines that a zoom-in operation or a zoom-out operation has been performed (YES in S4), the controller 5 displays, on the display unit 2, an image obtained through zooming-in or zooming-out in accordance with the amount of the operation. After that, the process proceeds to S6. In contrast, if the controller 5 determines that a zoom-in operation or a zoom-out operation has not been performed (NO in S4), the controller 5 does not perform S5 and proceeds to S6.

In S6, the controller 5 determines whether an instruction to capture an image has been transmitted. For example, when a user operates the image capture switch 8 displayed on the display unit 2, the controller 5 determines that an instruction to capture an image has been transmitted. If the controller 5 determines that an instruction to capture an image has been transmitted (YES in S6), the controller 5 stores, in the storage unit 6, the image displayed on the display unit 2 at that time (S7). After that, the process proceeds to S8. In contrast, if the controller 5 determines that an instruction to capture an image has not been transmitted (NO in S6), the controller 5 does not perform S7 and proceeds to S8.

In S8, the controller 5 determines whether an instruction to stop the camera 10 has been transmitted. If the controller 5 determines that an instruction to stop the camera 10 has been transmitted (YES in S8), the controller 5 terminates the image capture application and stops the function of the camera 10 (S9). In contrast, if the controller 5 determines that an instruction to stop the camera 10 has not been transmitted (NO in S8), the controller 5 causes the process to return to S4. The processes in S4, S6, and S8 are repeatedly performed until the determination result in S8 is YES.

### Advantages of the Portable Terminal 1

The camera 10 of the portable terminal 1 is an ultra wide-angle camera. If an image of the full angle of view, which is photographed by using the camera 10, is displayed on the display unit 2 as it is as the default, the image capture area is too wide, and a user may feel uncomfortable about too small subjects that are to be photographed. In the configuration described above, in the default shooting, an image having the full angle of view of the camera 10 which is an ultra wide-angle camera is not used, and a zoom process is performed until the angle of view decreases to the predetermined angle of view which is smaller than the full angle of view. The angle of view obtained through zooming is used as the default angle of view. Thus, a user may operate the camera 10 without feeling uncomfortable as described above, and the usability is improved.

The camera 10, which is a single ultra wide-angle camera, covers the image capture area of the wide-angle camera. Thus, compared with the configuration in which a portable terminal has both an ultra wide-angle camera and a wide-angle camera, a reduction in the cost is achieved. In addition, an angle of view obtained through zooming is used as the default angle of view. Thus, a zoom-out operation for widening the angle of view with respect to the default may be performed. An operational feeling of having both a wide-angle camera and an ultra wide-angle camera may be obtained.

The portable terminal 1 covers the image capture area including that of a telephoto camera, by using the single camera 10. Therefore, compared with the configuration of a portable terminal having three cameras, an ultra wide-angle camera, a wide-angle camera, and a telephoto camera, the portable terminal 1 may reduce the cost more effectively.

The portable terminal 1 may have a telephoto camera separately from the camera 10. That is, when the camera 10 is regarded as a first camera (first image capture unit), the portable terminal 1 may further have a second camera (second image capture unit) having a 35 mm equivalent focal length of 50 mm or more. In this case, for example, when the UI-display zoom factor exceeds two, the controller of the portable terminal switches the camera, which is being used, from the first camera (camera 10) to the second telephoto camera.

### Implementation Examples Using Software

The function of the portable terminal 1 may be implemented by using a program for functioning a computer as the image capture device. The program is used to function the computer as the control blocks (especially, the units included in the controller 5 and the image processor 14) of the image capture device.

In this case, the image capture device includes a computer which has at least one control device (for example, a processor) and at least one storage device (for example, a memory) as hardware for executing the program. Execution of the program using the control device and the storage device achieves the functions described in the embodiments.

The program may be stored in one or more non-transitory computer-readable recording media. The recording media may, or may not, be provided for the image capture device. In the case where the recording media are not provided for the image capture device, the program may be supplied to the image capture device through any wired or wireless transmission medium.

Some or all of the functions of the control blocks may be implemented by using logic circuits. For example, an integrated circuit, which includes the logic circuits functioning as the control blocks, is also encompassed in the scope of the present disclosure. In addition, for example, the functions of the control blocks may be implemented by using a quantum computer.

### CONCLUSION

An image capture device (portable terminal 1) according to a first aspect of the present disclosure includes an image capture unit (camera 10), a display unit 2, a zoom processor (image processor 14), and a reception unit (operation unit 4). The image capture unit (camera 10) has a 35 mm equivalent focal length of 20 mm or less. The display unit 2 displays an image captured by the image capture unit. The zoom processor (image processor 14) zooms in/out on an image captured by the image capture unit. The reception unit (operation unit 4) receives input of the amount of a process performed by the zoom processor. In default shooting by the image capture unit, the zoom processor performs a zoom process to obtain a focal length of a predetermined value between 23 mm and 26 mm in 35 mm equivalent, and an angle of view obtained through the zoom process is used as a default angle of view.

The image capture device according to a second aspect of the present disclosure may have a configuration in which, in the first aspect, the zoom processor performs the zoom process up to an angle of view corresponding to a 35 mm equivalent focal length of 50 mm or more. The zoom process is performed in accordance with the input amount of the process.

The image capture device according to a third aspect of the present disclosure may have a configuration of, in the first aspect, further including a second image capture unit having a 35 mm equivalent focal length of 50 mm or more. The image capture unit is regarded as a first image capture unit.

The image capture device according to a fourth aspect of the present disclosure may have a configuration in which, in any of the first to third aspects, the reception unit receives input of the amount of the process by using the default angle of view as a zoom factor of one.

The present disclosure is not limited to the embodiments described above. Within the scope indicated by claims, various changes may be made. An embodiment obtained by combining technical units, which are disclosed in different embodiments, with each other appropriately is also encompassed in the technical scope of the present disclosure. Further, by combining technical units, which are disclosed in the embodiments, with each other, novel technical characteristics may be formed.

The present disclosure contains subject matter related to that disclosed in Japanese Priority Patent Application JP 2021-079364 filed in the Japan Patent Office on May 7, 2021, the entire contents of which are hereby incorporated by reference.

What is claimed is:

1. An image capture device comprising:
an image capture unit that has a 35 mm equivalent focal length of 20 mm or less;
a display unit that displays an image captured by the image capture unit;
a zoom processor that zooms in/out on an image captured by the image capture unit; and
a reception unit that receives input of an amount of a process performed by the zoom processor,
wherein, in default shooting by the image capture unit, the zoom processor performs a zoom process to obtain a focal length of a predetermined value between 23 mm and 26 mm in 35 mm equivalent, and an angle of view obtained through the zoom process is used as a default angle of view.

2. The image capture device according to claim 1,
wherein the zoom processor is capable of performing the zoom process up to an angle of view corresponding to a 35 mm equivalent focal length of 50 mm or more, the zoom process being performed in accordance with the input amount of the process.

3. The image capture device according to claim 1, further comprising:
a second image capture unit having a 35 mm equivalent focal length of 50 mm or more, the image capture unit being regarded as a first image capture unit.

4. The image capture device according to claim 1,
wherein the reception unit receives input of the amount of the process by using the default angle of view as a zoom factor of one.
